(19) United States
(12) Patent Application Publication
(10) Pub. No.: US 2009/0150559 A1
(43) Pub. Date: Jun. 11, 2009

(54) PROVIDING CONTENT SYNCHRONIZED WITH A PRODUCTION

(75) Inventor: Walter L. Robb, Schenectady, NY (US)

Correspondence Address: HOFFMAN WARNICK LLC, 75 STATE STREET, 14TH FLOOR, ALBANY, NY, 12207, US

(73) Assignee: CRAFTSMAN & SCRIBE'S CREATIVE WORKSHOP, INC., Niskayuna, NY (US)

(21) Appl. No.: 12/329,105

(22) Filed: Dec. 5, 2008

Related U.S. Application Data
(60) Provisional application No. 60/992,748, filed on Dec. 6, 2007.

(51) Int. Cl. G06F 15/16

(52) U.S. Cl. 709/231

(57) ABSTRACT

A solution for providing content synchronized with a production is provided. The solution obtains a plurality of possible start times for the production, the plurality of possible start times being based upon at least one of: a length of the production or a broadcast schedule policy; and repeatedly initiates a content stream to coincide with each of the possible start times without regard to an actual start time for the production.

### REFERENCE TO PRIOR APPLICATIONS

The current application claims the benefit of co-pending U.S. Provisional Application No. 60/992,748, titled “Synchronized Content for a Transmitted and/or Recorded Production”, which was filed on 6 Dec. 2007, and which is hereby incorporated by reference.

### TECHNICAL FIELD

The disclosure relates generally to providing synchronized content, and more particularly, to providing content synchronized with a production.

### BACKGROUND

Various approaches seek to synchronize content with a production. For example, one approach attempts to synchronize content with a production by providing content synchronized with a known production start time. Further, another approach seeks to provide content synchronized with a production using a local broadcast time or an international broadcast time. Even further, another approach seeks to provide content synchronized with a production by storing the production on a memory and synchronizing playback using time stamps. Still another approach attempts to provide content synchronized with a production by sending uniform resource locators (URLs) along with television signals.

### SUMMARY OF THE INVENTION

Aspects of the invention provide a solution for providing content synchronized with a production. A first aspect of the invention provides a method of providing content synchronized with a production, the method comprising: obtaining a plurality of possible start times for the production, the plurality of possible start times being based upon at least one of: a length of the production or a broadcast schedule policy; and repeatedly initiating a content stream to coincide with each of the possible start times without regard to an actual start time for the production.

A second aspect of the invention provides a system for providing content synchronized with a production, the system comprising: a component configured to obtain a plurality of possible start times for the production, the plurality of possible start times being based upon at least one of: a length of the production or a broadcast schedule policy; and a component configured to repeatedly initiate a content stream to coincide with each of the possible start times without regard to an actual start time for the production.

A third aspect of the invention provides a computer program comprising program code embodied in at least one computer-readable medium, which when executed, enables a computer system to implement a method of providing content synchronized with a production, the method comprising: obtaining a plurality of possible start times for the production, the plurality of possible start times being based upon at least one of: a length of the production or a broadcast schedule policy; and repeatedly initiating a content stream to coincide with each of the possible start times without regard to an actual start time for the production.

A fourth aspect of the invention provides a method of generating a system for providing content synchronized with a production, the method comprising: providing a computer system operable to: obtain a plurality of possible start times for the production, the plurality of possible start times being based upon at least one of: a length of the production or a broadcast schedule policy; and repeatedly initiate a content stream to coincide with each of the possible start times without regard to an actual start time for the production.

A fifth aspect of the invention provides a method comprising: at least one of providing or receiving a copy of a computer program that is embodied in a set of data signals, wherein the computer program enables a computer system to implement a method of providing content synchronized with a production, the method comprising: obtaining a plurality of possible start times for the production, the plurality of possible start times being based upon at least one of: a length of the production or a broadcast schedule policy; and repeatedly initiating a content stream to coincide with each of the possible start times without regard to an actual start time for the production.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWING

These and other features of the disclosure will be more readily understood from the following detailed description of the various aspects of the invention taken in conjunction with the accompanying drawing that depicts various aspects of the invention.

FIG. 1 shows an illustrative environment for providing content synchronized with a production according to an embodiment.

It is noted that the drawing is not necessarily to scale. The drawing is intended to depict only typical aspects of the invention, and therefore should not be considered as limiting the scope of the invention.

### DETAILED DESCRIPTION OF THE INVENTION

As indicated above, aspects of the invention provide a solution for providing content synchronized with a production. As used herein, unless otherwise noted, the term “set” means one or more (i.e., at least one) and the phrase “any solution” means any now known or later developed solution.

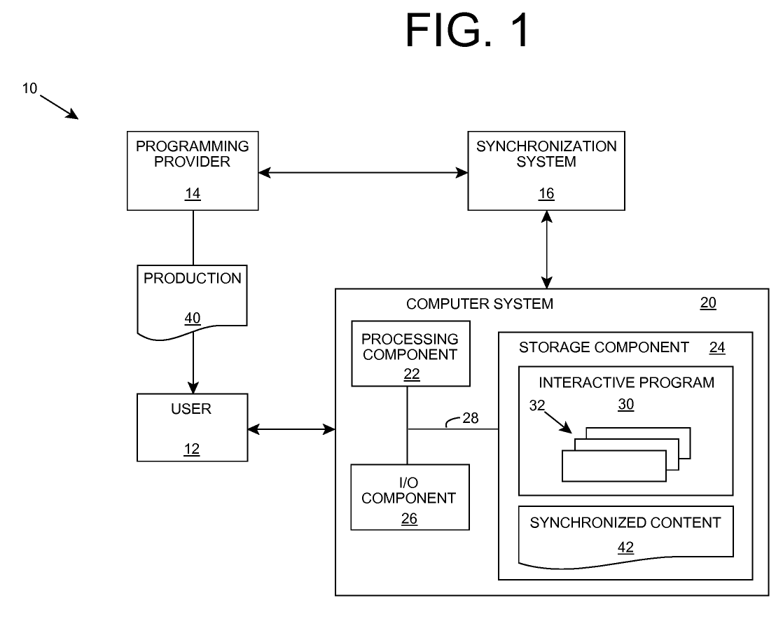

Turning to the drawing, FIG. 1 shows an illustrative environment 10 for providing content 42 synchronized with a production 40 according to an embodiment. To this extent, environment 10 includes a computer system 20 that can perform a process described herein in order to provide content 42 synchronized with production 40 for use by a user 12. In particular, computer system 20 is shown including an interactive program 30, which makes computer system 20 operable to provide content 42 synchronized with production 40 by performing a process described herein.

Computer system 20 is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, processing component 22 executes program code, such as interactive program 30, which is at least partially stored in storage component 24. While executing program code, processing component 22 can process data, which can result in reading and/or writing transformed data from/to storage component 24 and/or I/O component 26 for further processing. Pathway 28 provides a communications link between each of the components in computer system 20. I/O component 26 can comprise one or more human I/O devices, which enable a human user 12 to interact with computer system 20 and/or one or more communications devices to enable a system user 12 to communicate with computer system 20 using any type of communications link. To this extent, interactive program 30 can manage a set of interfaces (e.g., graphical user interface(s), application program interface, and/or the like) that enable human and/or system users 12 to interact with interactive program 30. Further, interactive program 30 can manage (e.g., store, retrieve, create, manipulate, organize, present, etc.) the data, such as synchronized content 42, using any solution.

In any event, computer system 20 can comprise one or more general purpose computing articles of manufacture (e.g., computing devices) capable of executing program code, such as interactive program 30, installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, interactive program 30 can be embodied as any combination of system software and/or application software. Further, interactive program 30 can be implemented using a set of modules 32. In this case, a module 32 can perform a set of actions used by interactive program 30, and can be separately developed and/or implemented from other portions of interactive program 30. As used herein, the term “component” means any configuration of hardware, with or without software, which implements and/or enables a computer system 20 to implement the functionality described in conjunction therewith using any solution, while the term “module” means program code that enables a computer system 20 to implement the functionality described in conjunction therewith using any solution. When fixed in a tangible medium of expression, a module is a component. Regardless, it is understood that two or more components, modules, and/or systems may share some/all of their respective hardware and/or software. Further, it is understood that some of the functionality discussed herein may not be implemented or additional functionality may be included as part of computer system 20.

When computer system 20 comprises multiple computing devices, each computing device can have only a portion of interactive program 30 installed thereon (e.g., one or more modules 32). However, it is understood that computer system 20 and interactive program 30 are only representative of various possible equivalent computer systems that may perform a process described herein. To this extent, in other embodiments, the functionality provided by computer system 20 and interactive program 30 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 20 includes multiple computing devices, the computing devices can communicate over any type of communications link. Further, while performing a process described herein, computer system 20 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, interactive program 30 enables computer system 20 to provide content 42 synchronized with production 40 for use by a user 12. While only a single programming provider 14, user 12, and production 40/synchronized content 42 pair are shown and described, it is understood that computer system 20 can simultaneously support any number of programming providers 14, users 12, and production 40/synchronized content 42 pairs. For example, computer system 20 can include content 42 that is configured to be synchronized with multiple episodes of a particular television/radio series as well as multiple television/radio programs, each of which has multiple episodes. One or more of the multiple episodes may be simultaneously provided for use by one or more users 12.

In one embodiment, production 40 may be a part of one of many series of, for example, hundreds of productions 40 for which computer system 20 can provide synchronized content 42. In this case, computer system 20 can enable user 12 to identify each production 40 by a production name and production number (e.g., episode number). The production name and production number may, for example, be displayed on a screen at the beginning of production 40, available in an index or a guide, part of a label or file name associated with a data file, and/or the like. In any case, computer system 20 may use the production name and production number to provide synchronized content 42 for a production 40 in a series of productions. For example, computer system 20 can enable selection of synchronized content 42 by user 12 using the production name and/or number.

In any event, synchronized content 42 is any data, audio, visual, and/or the like, which is configured for presentation to user 12 in a manner such that the presentation of certain data in synchronized content 42 is timed to coincide with and enhance content of production 40 at a particular time within production 40. Synchronized content 42 can be generated and stored using any solution. To this extent, synchronized content 42 can comprise data that represents a series of slides, such as a presentation, each of which computer system 20 causes to be displayed for a time period that corresponds with a length of time in production 40. For example, synchronized content 42 can include multiple ordered slides, each of which has a corresponding time period. The sum of the individual time periods can approximately equal the running time of production 40. Computer system 20 can provide each slide for presentation to user 12 in the specified order and separated by the corresponding time periods.

Additionally, computer system 20 can enable user 12 to request non-synchronized content. To this extent, synchronized content 42 can enable user 12 to access content that is not synchronized with production 40 (e.g., via a link in the synchronized content, a link in a display area/window used to frame the synchronized content, and/or the like) to obtain further information that is related to the production 40. Computer system 20 can present the non-synchronized content for display by user 12 in place of synchronized content, in a new display window, adjacent to synchronized content, or the like. When viewing non-synchronized content accessed while connected to synchronized content, the non-synchronized content, a window/display area used to frame the non-synchronized content, and/or the like, can enable user 12 to return to the synchronized content 42, which will present the content corresponding to the time in the production 40. Further, computer system 20 and/or synchronized content 42 can enable additional interaction from user 12. For example, user 12 can generate and submit user generated content (e.g., text, audio, image data, and/or the like), which user 12 can submit to computer system 20 using any solution. Subsequently, computer system 20 can provide the user generated content to programming provider 14, which may subsequently incorporate the user generated content in a future production 40.

In an embodiment, programming provider 14 is a broadcast and/or cable television channel, radio station, or other type of programming provider, which provides production 40 for viewing/listening by user 12 according to a predetermined programming schedule. Typically, production 40 may be provided via multiple programming providers 14, e.g., located in different geographic regions and/or a single programming provider 14 may provide production 40 multiple times during a given programming period (e.g., day, week, season, and/or the like). Production 40 can comprise a recorded or live program that is transmitted (e.g., broadcast or otherwise transmitted) by programming provider 14 at a predetermined time. When production 40 is a live program, some or all of synchronized content 42, such as the timing information, can be generated during the live transmission, and stored for later use for a recorded presentation of production 40.

In any event, computer system 20 can obtain the start time for each presentation of production 40 by each programming provider 14 so that computer system 20 can begin providing synchronized content 42 at the appropriate time(s) for use by user(s) 12. However, this can be difficult, particularly when there are numerous programming providers 14 (e.g., public broadcasting stations) that provide the same production 40 at varying times of the programming period, in various time zones, etc. To this extent, computer system 20 can obtain a plurality of possible start times for production 40.

In an embodiment, computer system 20 makes one or more assumptions with respect to the start time(s) in order to obtain the plurality of possible start times. Assumptions may be based upon information related to a length of the production. For example, when the running time of production 40 is less than or equal to a half hour, computer system 20 can assume that a programming provider 14 may begin a presentation of production 40 on every half hour (e.g., 12:00, 12:30, 1:00, etc.). Similarly, when the running time of production 40 is more than a half hour, but less than or equal to an hour, computer system 20 can assume that a programming provider 14 may begin a presentation of production 40 on every hour (e.g., 12:00, 1:00, 2:00, etc.). Still further, computer system 20 can assume that a programming provider 14 may begin a presentation of production 40 on every half hour, regardless of the running time of production 40.

Further, computer system 20 can make assumptions about when a production 40 will be presented by a programming provider 14 based upon a broadcast schedule policy of the programming provider 14. For example, a programming provider 14 may have a broadcast schedule policy which dictates that each production 40 starts at exactly the hour or half-hour mark. Further, programming provider 14 may synchronize a start time of production 40 with, for example, Greenwich Mean Time (GMT). It is also possible that programming provider 14 may send time data along with production 40 in the form of a time packet. A time packet may be sent, for example, via an Extended Data Service (XDS).

Additionally, computer system 20 can make assumptions about when a production 40 will not be presented by any programming provider 14 based upon an intended audience for the production 40, and not provide content 42 during these time periods. For example, when all programming providers 14 are located in the same time zone and production 40 is targeted at pre-school children, computer system 20 could assume that production 40 will not be presented between 10:00 pm and 3:00 am local time. Further, computer system 20 can group possible start times for the production 40 into time intervals for ease of managing synchronized content 42. In this case, time intervals representing possible start times for the production 40 may be several hours in length, or may cover a majority of a twenty-four hour period.

Computer system 20 can also make assumptions about when a production 40, which is part of a series of productions, will not be presented by any programming provider 14 based upon its part in the series. For example, when a production 40 is part of a season series, computer system 20 could assume that production 40 will not be presented before other productions in the season series that precede production 40. For example, computer system 20 can enable selection of synchronized content 42 by user 12 using the production name and/or number

In any event, computer system 20 can repeatedly initiate a content stream for synchronized content 42 to coincide with each of the possible start times without regard to an actual start time for the production 40. As described above, computer system 20 may make assumptions about when a production 40 will be presented, and those assumptions may not involve knowledge of an actual start time for the production 40. As used herein, the phrase content stream refers to a presentation that is initiated by computer system 20 for which synchronized content 42 may be provided for presentation to one or more users 12. For example, for a given production 40, computer system 20 can initiate a first content stream for the corresponding synchronized content 42 that will be synchronized with a start time of 12:00, a second content stream that will be synchronized with a start time of 12:30, etc. Subsequently, in order to receive synchronized content 42 in conjunction with the presentation (e.g., transmission) of a production 40, user 12 can access an interface provided by computer system 20 (e.g., a website) and select the corresponding content stream using any solution (e.g., by program name/start time/episode identifier, by programming provider 14, and/or the like).

Computer system 20 can manage the content stream using any solution. For example, computer system 20 can provide an update to a display (e.g., a new slide) for presentation to one or more users 12 on demand (e.g., upon expiration of a previous time period). Alternatively, computer system 20 can provide one or more updates in advance of the actual presentation, and communicate a signal to trigger the update at a corresponding time. In another alternative, computer system 20 can provide each display with a corresponding time period in a burst, and a local computer system for user 12 can manage the updates to the presentation. Further, a user 12 may connect to a content stream that has previously begun. In this case, computer system 20 can provide the current content (e.g., slide) for presentation to user 12, without providing any content that may have already been displayed previously. It is understood that these management solutions are only illustrative of numerous solutions that can be implemented by computer system 20.

A problem arises in sufficiently matching the actual start times of both the production 40 and the content stream for synchronized content 42 so that the two presentations are properly synchronized. For example, a clock in computer system 20 may be some seconds or even minutes different from a clock used by programming provider 14 when starting production 40. Such a difference can be frustrating for user 12 due to a discrepancy in the presentations. In an embodiment, computer system 20 determines a precise time on which the start time is based using a time received from a synchronization system 16. Synchronization system 16 can comprise any type of third party system for providing a precise time, e.g., the U.S. Naval Observatory satellite. Further, programming provider 14 can similarly determine the start time for production 40 based on a time provided by the same synchronization system 16. Alternatively, computer system 20 can obtain the actual time from programming provider 14 or vice versa. In any event, computer system 20 can periodically obtain the precise time from synchronization system 16 and/or programming provider 14, using any solution.

The various data stream(s) of synchronized content 42 also can be used for on demand viewing of production 40. For example, user 12 can start playback of a stored copy of production 40 at a time that coincides with the computer system 20 starting a data stream for the corresponding synchronized content 42 (e.g., on the half hour). In this case, computer system 20 could start data streams based solely upon a length of the production and/or a time. Alternatively, computer system 20 can start a data stream for synchronized content 42 in response to a request from user 12 in addition to providing the periodic data streams. Regardless, computer system 20 can provide introductory content (e.g., a countdown or the like) to assist user 12 in manually synchronizing the playback of production 40 with the data stream for synchronized content 42. Alternatively, the two can be automatically synchronized using any solution (e.g., a signal from one system to another, one task to another within the same computer system, and/or the like).

Additionally, computer system 20 can enable user 12 to obtain synchronized content 42 apart from using a timed data stream, e.g., without synchronization with a production 40. In this case, user 12 can review synchronized content 42 apart from production 40. For example, a user 12 can request to display synchronized content 42 as a slide show, in which user 12 decides when to change to the next/previous slide instead of the timing information that is used to synchronize the content with the production 40. In this case, computer system 20 can provide synchronized content 40 (e.g., a presentation) without the corresponding timing information, and user 12 can review the content from a particular production 40, access non-synchronized content to obtain additional information, and/or the like.

In an illustrative embodiment, computer system 20 comprises a web server that manages a website that is accessed by user 12 using a local computer. In this case, the web server can manage the timing for the presentation of synchronized content 42, with the local computer only being used to display the changes provided by the web server. Alternatively, the web server can provide a program (e.g., some or all of interactive program 30) to the local computer, which enables the local computer to manage some or all of the synchronized changes to the presentation of synchronized content 42 (e.g., start of the presentation, change from one slide to another, and/or the like). In the latter case, all of synchronized content 42 (e.g., slides with timing information) could be communicated to the local computer ahead of the start time of production 40. Further, when implemented by the local computer, the local computer could obtain synchronization information from synchronization system 16 and/or programming provider 14 as discussed herein.

In an embodiment, synchronized content 42 includes content that is interactive, and enables user 12 to obtain additional data, change data, submit data to programming provider 14 and/or another party, and/or the like. The following description is an illustrative example of an application, which can be implemented by environment 10.

An illustrative application comprises a half-hour recorded television production 40 that teaches children how to draw. Production 40 can start out describing one element of art known as “architectural.” It can highlight a leading architect, e.g., Frank Lloyd Wright, and can show some of his well-known homes. Then the tools that an architect uses such as pencils, right triangle, t-square, etc., can be described and shown. Subsequently, the instructor in production 40 can show children how to draw a home in 3-D perspective. For example, children can learn how to use the horizon to get proper perspective. Next, the instructor can color the drawing and show how shading improves the picture. During production 40, the instructor can continually encourage the children to make similar drawings and then submit them via email to a web address, or the like. Additionally, production 40 might show drawings submitted from previous productions 40 in the series. The instructor can finish production 40 by featuring a “doodle” drawing in which he draws a “squiggly” line and then, using his imagination, makes the doodle become a recognizable object.

Meanwhile, when the instructor begins talking about architecture, synchronized content 42 can show a blueprint of a home. When he talks about Frank Lloyd Wright, synchronized content 42 can show a photo of Frank Lloyd Wright with hypertext at the bottom of the page that user 12 can click for “more information.” The hypertext could open a new web page that shows more background information than what the instructor is relating about Frank Lloyd Wright in production 40. User 12 can thus simultaneously watch production 40, synchronized content 42, as well as obtain more detailed information, if so desired.

When the instructor talks about drawing instruments, user 12 can learn how to make a T-square out of cardboard or plastic, and how to create a right triangle. With these instruments, user 12 can make a perspective drawing of a house, for example. Also, when the instructor does a doodle, user 12 can click onto a drawing palette in synchronized content 42, which allows user 12 to use the mouse to make and color his/her own doodle drawings and permit him/her to email it to a web address.

While shown and described herein as a method and system for providing content synchronized with a production, it is understood that aspects of the invention further provide various alternative embodiments. For example, in one embodiment, the invention provides a computer program fixed in at least one computer-readable medium, which when executed, enables a computer system to provide content synchronized with a production. To this extent, the computer-readable medium includes program code, such as interactive program 30, which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as interactive program 30 (FIG. 1), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In another embodiment, the invention provides a method of generating a system for providing content synchronized with a production. In this case, a computer system, such as computer system 20, can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

It is understood that aspects of the invention can be implemented as part of a business method that performs a process described herein on a subscription, advertising, and/or fee basis. That is, a service provider could offer to provide content synchronized with a production as described herein. In this case, the service provider can manage (e.g., create, maintain, support, etc.) a computer system, such as computer system 20, that performs a process described herein for one or more customers (e.g., programming providers 14). In return, the service provider can receive payment from the customer(s) under a subscription and/or fee agreement, receive payment from the sale of advertising to one or more third parties (e.g., user 12), and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of providing content synchronized with a production, the method comprising:
obtaining a plurality of possible start times for the production, the plurality of possible start times being based upon at least one of: a length of the production or a broadcast schedule policy; and
repeatedly initiating a content stream to coincide with each of the possible start times without regard to an actual start time for the production.

2. The method of claim 1, further including periodically updating the content stream.

3. The method of claim 1, further including:
receiving a request for additional content from a user receiving the content stream; and
providing the additional content for use by the user apart from the content stream in response to the request.

4. The method of claim 1, further including:
receiving user generated content from a user receiving the content stream; and
providing the user generated content for use by a programming provider of the production.

5. The method of claim 1, wherein the production is a part of a series of productions and wherein the plurality of possible start times is further based upon an episode of the production in the series of productions.

6. The method of claim 1, wherein the content stream includes a series of slides with timing information, the method further comprising enabling a user to view the series of slides without the timing information.

7. The method of claim 1, further comprising synchronizing the repeatedly initiating to a time received from a synchronization system.

8. A system for providing content synchronized with a production, the system comprising:
a component configured to obtain a plurality of possible start times for the production, the plurality of possible start times being based upon at least one of: a length of the production or a broadcast schedule policy; and
a component configured to repeatedly initiate a content stream to coincide with each of the possible start times without regard to an actual start time for the production.

9. The system of claim 8, further including a component configured to periodically update the content stream.

10. The system of claim 8, further including:
a component configured to receive a request for additional content from a user receiving the content stream; and
a component configured to provide the additional content for use by the user apart from the content stream in response to the request.

11. The system of claim 8, further including:
a component configured to receive user generated content from a user receiving the content stream; and
a component configured to provide the user generated content for use by a programming provider of the production.

12. The system of claim 8, wherein the production is a part of a series of productions and wherein the plurality of possible start times is further based upon an episode of the production in the series of productions.

13. The system of claim 8, wherein the content stream includes a series of slides with timing information, the system further comprising a component configured to enable a user to view the series of slides without the timing information.

14. The system of claim 8, further comprising a component configured to synchronize the repeatedly initiating to a time received from a synchronization system.

15. A computer program comprising program code embodied in at least one computer-readable medium, which when executed, enables a computer system to implement a method of providing content synchronized with a production, the method comprising:
obtaining a plurality of possible start times for the production, the plurality of possible start times being based upon at least one of: a length of the production or a broadcast schedule policy; and
repeatedly initiating a content stream to coincide with each of the possible start times without regard to an actual start time for the production.

16. The computer program of claim 15, the method further comprising periodically updating the content stream.

17. The computer program of claim 16, the method further comprising:
receiving a request for additional content from a user receiving the content stream; and
providing the additional content for use by the user apart from the content stream in response to the request.

18. The computer program of claim 15, the method further comprising:
receiving user generated content from a user receiving the content stream; and
providing the user generated content for use by a programming provider of the production.

19. The computer program of claim 15, wherein the production is a part of a series of productions and wherein the plurality of possible start times is further based upon an episode of the production in the series of productions.

20. The computer program of claim 15, wherein the content stream includes a series of slides with timing information, the method further comprising enabling a user to view the series of slides without the timing information.
